(19) United States
(12) Patent Application Publication
(10) Pub. No.: US 2006/0255494 A1
(43) Pub. Date: Nov. 16, 2006

(54) Polymer composite material and process for producing the same

(76) Inventors: Takashi Ohtomo, Yonezawa-shi (JP); Takashi Inoue, Yonezawa-shi (JP); Takashi Kuriyama, Yonezawa-shi (JP)

Correspondence Address: PITNEY HARDIN LLP, 7 TIMES SQUARE, NEW YORK, NY, 10036-7311, US

(21) Appl. No.: 10/545,308

(22) PCT Filed: Feb. 12, 2004
(86) PCT No.: PCT/JP04/01505

§ 371 Date: Dec. 27, 2005

(30) Foreign Application Priority Data
Feb. 14, 2003 (JP) 2003-036175

(51) Int. Cl. C08K 3/34; B29C 63/00

(52) U.S. Cl. 264/171.1; 524/445

(57) ABSTRACT

A polymer composite material which comprises a thermoplastic resin and a lamellar inorganic compound dispersed therein on the order of submicron to nanometer and which is excellent in mechanical properties, heat resistance, etc.; and a production process which comprises kneading a thermoplastic resin together with a lamellar inorganic compound swollen with a dispersion medium comprising water and/or an organic solvent with a shearing kneader at a temperature which is lower than the melting temperature of the thermoplastic resin and not higher than the boiling point of the dispersion medium and then kneading the resultant mixture while heating it to a temperature not lower than the boiling point of the dispersion medium. By the production process, a polymer composite material containing a lamellar inorganic compound is obtained which has the desired properties.

### TECHNICAL FIELD

The present invention relates to a process for producing a polymer composite material comprising a thermoplastic resin containing a lamellar inorganic compound and a polymer composite material produced by the process. More particularly, the present invention relates to a process for producing a polymer composite material comprising a thermoplastic resin and a lamellar inorganic compound dispersed therein on the order of submicron to nanometer and the polymer composite material.

### BACKGROUND ART

Conventionally, in order to improve the respective properties, particularly mechanical properties of a polymer compound such as a thermoplastic resin, compounding of an inorganic filler such as a glass fiber, talc, mica or clay has been performed. In particular, a polymer composite material comprising a thermoplastic resin and a lamellar inorganic compound dispersed therein on the order of submicron to nanometer has attracted attention recently. For example, typical examples of the lamellar inorganic compound may include smectite clay minerals such as montmorillonite, hectorite and saponite. It is known that these have a structure in which about several hundreds to several thousands of unit layers with a thickness of about 1 nm are stacked and aggregated, and have a hydration property, therefore, they are swollen infinitely by migration of water molecules, and particularly in a diluted aqueous solution, most part thereof is separated into a unit layer.

In this way, if a lamellar structure is delaminated and separated into several layer units or a unit layer, the aspect ratio (the ratio of the length of the longest axis to the length of the shortest axis thereof) and the specific surface area will become significantly large. Therefore, if a lamellar inorganic compound can be finely dispersed in a resin in such a state, a significant reinforcing effect can be imparted. It has been reported that not only can such a polymer composite material exhibit higher elasticity or heat resistance even in a small amount compared with a composite material in which a conventional inorganic filler is incorporated, but also can it impart a property such as a gas barrier property, a vibration controlling property, fatigue resistance, chemical resistance or flame retardancy depending on the type of a thermoplastic resin. In addition, replacement with glass fiber is also possible, and recycling thereof becomes easy, therefore, it has been brought to attention in terms of environment problems. However, these lamellar inorganic compounds have a strong cohesive force, and in many cases, have a weak affinity for a thermoplastic resin, whereby practically, it is difficult to finely disperse such a lamellar inorganic compound in a thermoplastic resin. For example, by only melt-kneading a lamellar inorganic compound together with a resin, they only dispersed as block particles in which many unit layers are stacked and aggregated, and at a small compounding ratio, an improving effect on mechanical strength, heat resistance or the like cannot be sufficiently obtained.

In order to improve the dispersibility of a lamellar inorganic compound, various techniques such as an intercalation method and a melt kneading method have been proposed so far. For example, in JP-A-63-215775, a method in which a lamellar inorganic compound is organized with an organic cation represented by a quaternary ammonium salt, and a monomer is introduced between the layers, whereby polymerization reaction is allowed to occur in the interlayer is disclosed. In addition, in JP-A-8-302062, a method in which an organized lamellar inorganic compound is dispersed in an organic solvent in an infinitely swollen state, and the compound is melt-kneaded together with a thermoplastic resin is disclosed. In addition, in JP-A-9-217012, a method in which an organized lamellar inorganic compound and a thermoplastic resin are melt-kneaded under a high shearing force is disclosed. Further, in JP-A-9-183910, a method in which a lamellar inorganic compound which is swollen with water and/or an organic solvent, or an organized lamellar inorganic compound which is swollen with an organic solvent is melt-kneaded under specific conditions is disclosed, and in JP-A-2000-239397, a method in which a thermoplastic resin, a large amount of water or a solvent containing a proton donor, a lamellar inorganic compound and an agent for dispersing it are kneaded while they are brought into contact with each other at a temperature which is not lower than the melting temperature of the thermoplastic resin under a sealed condition is disclosed. In addition, in JP-A-2002-155208 and JP-A-2002-234948, a method in which a lamellar inorganic compound is dispersed in water or a dispersion medium containing a proton donor and an organizing agent is added thereto to adjust a dispersion solution of an organized lamellar inorganic compound, then the dispersion medium is removed to obtain an organized lamellar inorganic compound in the form of cake, which retains a specific amount of the dispersion medium, then, the organized lamellar inorganic compound is melt-kneaded together with a thermoplastic resin is disclosed. However, in general, the polymerization method needs the enormous cost of equipment, and moreover, it is not suitable for producing a wide variety of products. Furthermore, it is difficult to efficiently and economically perform production since it takes a long time for polymerization reaction and controlling. In particular, when the content of a lamellar inorganic compound becomes large, there was a tendency that the production efficiency became lower, and also the lamellar inorganic compound dispersed non-homogeneously. In addition, in the melt kneading method, since a general extruder or the like is used, it is possible to produce a wide variety of products and also to reduce the cost of equipment, however, it is necessary to subject a lamellar inorganic compound to an organization treatment, a purification and drying treatment, a grinding treatment or the like in advance for increasing its affinity for a resin, and as a result, the production process becomes complicated, whereby there was a problem in that it takes time and cost. Further, in the case where a swelling treatment is performed with water or an organic solvent, secondary aggregation of the lamellar inorganic compound during melt-kneading occurred in some cases, and there was also a problem of the productivity such as a decrease in a discharged amount. On the other hand, in JP-A-2002-347020, a method in which ultra-fine powder with a particle size of less than 0.1 μm and a thermoplastic resin are kneaded in a state between a semi-solid state and a molten state of the raw material resin with a tubular millstone type kneader composed of a cylinder, plural rotary discs and fixed discs, which are concentrically mounted in the cylinder, whereby secondary particles of ultra-fine powder of a nanometer order are crushed to form primary particles and are dispersed in the resin is proposed. By using this apparatus, even if a raw material resin is in a semi-solid state, it can be kneaded by a millstone effect due to a shearing action in the clearance between the rotary discs and the fixed discs, therefore, the crushing efficiency of the ultra-fine powder is improved more compared with a general twin screw extruder. However, in the case where an ultra-fine powder is an ultra-thin layer body whose primary particle has a high aspect ratio such as a lamellar inorganic compound, it is difficult to less destroy the interlayer of the lamellar organic compound and to crush the lamellar inorganic compound homogeneously. Nevertheless, in order to improve the dispersibility of the lamellar inorganic compound in the resin, it is necessary to make measures such as employing a multipath system in which kneading is repeated multiple times, or increasing the number of cylinders and discs to be installed, and there is a problem in that the productivity is substantially decreased. In addition, because of the destruction of the interlayer of the lamellar inorganic compound, the aspect ratio becomes small, and there is also a problem in that a reinforcing effect is decreased.

An object of the present invention is to provide a process for industrially advantageously producing a polymer composite material which comprises a lamellar inorganic compound dispersed on the order of submicron to nanometer and is excellent in mechanical properties, heat resistance or the like with good productivity by a general and convenient step and a polymer composite material having the above-mentioned properties.

### Disclosure of the Invention

The present inventors have already proposed, as a method of recycling of a crushed material of waste bottle made of polyethylene terephthalate (hereinafter referred to as PET), shearing and kneading treatment at a temperature which is lower than the melting temperature of PET be effective in JP-A-2001-390058. This is accomplished by finding the fact that a crushed material of waste PET bottle can be sufficiently kneaded even at a temperature which is lower than the melting temperature with a general kneader such as a conventional twin screw extruder. One of the findings obtained here is that the form and the property of a raw material resin becomes an important factor of expanding the possibility of kneading. Specifically, even if it is the same PET, in the case where it is in the form of pellet and in a crystalline state like virgin PET, it is difficult to knead it at a temperature which is lower than the melting temperature (hereinafter referred to as kneading at low temperature in some cases), however, in the case where it is in the form of flake and in an amorphous state like a crushed material of waste PET bottle, it could be easily kneaded even with a general kneader. This suggests the possibility of kneading at low temperature with another resin. Further, the present inventors developed the application of this finding to a polylactic acid resin which shows a thermal behavior similar to PET, and proposed a method of kneading at low temperature of a lamellar inorganic compound swollen with water or an aqueous solvent together with polylactic acid as a technique of finely dispersing a lamellar inorganic compound in a polylactic acid resin (JP-A-2002-189066). The findings obtained here were that, also in the case of a polylactic acid resin like the case of PET, if its form and property is changed, kneading at low temperature becomes easy, kneading at low temperature is more effective in dispersing a lamellar inorganic compound than melt-kneading, when a lamellar inorganic compound is added in a state where it is swollen with water or an aqueous solvent, the dispersibility of the a lamellar inorganic compound is further improved and the like. The present inventors further developed these findings and made intensive studies on a process for producing a polymer composite material which can be applied to a wide variety of thermoplastic resins and comprises a lamellar inorganic compound dispersed on the order of submicron to nanometer with a convenient step at a low cost, and finally completed the present invention.

That is, the present invention provides a process for producing a polymer composite material characterized by kneading a thermoplastic resin together with a lamellar inorganic compound swollen with a dispersion medium comprising water and/or an organic solvent with a shearing kneader at a temperature which is lower than the melting temperature of the above-mentioned thermoplastic resin and not higher than the boiling point of the above-mentioned dispersion medium, whereby the lamellar inorganic compound is delaminated and dispersed (step of delamination and dispersion) and then kneading the resultant mixture while increasing the temperature to a temperature which is not lower than the boiling point of the dispersion medium, whereby the lamellar inorganic compound is dispersed homogeneously while the dispersion medium is removed by evaporation (step of removal of dispersion medium and homogenization of dispersion). In addition, the present invention also provides a polymer composite material which contains a thermoplastic resin and a lamellar inorganic compound at 0.01 to 100 parts by weight per 100 parts by weight of the thermoplastic resin, and in which the lamellar inorganic compound is finely dispersed in a state where the average thickness thereof is about 0.5 μm or less and the maximum thickness thereof is about 1 μm or less. The polymer composite material has excellent mechanical properties, heat resistance, moldability and the like.

### BEST MODE FOR CARRYING OUT THE INVENTION

Hereunder, the present invention will be specifically described. A thermoplastic resin to be used in the present invention is not particularly limited as long as it is a thermoplastic polymer compound that is solid at room temperature. Examples thereof include thermoplastic resins such as polyethylene, polypropylene, polyvinyl chloride, polyvinylidene chloride, polyvinyl acetate, ethylene-vinyl acetate copolymers, polystyrene, acrylonitrile-butadiene-styrene copolymers, acrylonitrile-styrene copolymers, polyethylene terephthalate, polybutylene terephthalate, polylactic acid, polycaprolactone, polybutylene succinate, polymethyl methacrylate, polyamide, polyacetal, polycarbonate, polyphenylene sulfide, polyphenylene ether, polyether ether ketone, polysulfone, polyethersulfone, polyamide-imide, polyetherimide and thermoplastic polyimide. Further, they may include a variety of rubbers such as natural rubber, isoprene rubber, butadiene rubber, styrene-butadiene rubber, chloroprene rubber, styrene rubber, nitrile rubber, butyl rubber, ethylene-propylene rubber, epichlorohydrin rubber, polysulfide rubber, acrylic rubber, polyurethane rubber, fluorocarbon rubber and silicone rubber, 1,2-polybutadiene, 1,4-polyisoprene, chlorinated polyethylene, styrene-butadiene-styrene block copolymers, styrene-isoprene-styrene block copolymers, styrene-ethylene-butylene-styrene block copolymers, styrene-ethylene-propylene-styrene copolymers, a mixture of polypropylene and an ethylene-propylene random copolymer, and a variety of thermoplastic elastomers comprising a hard segment and a soft segment such as a polyamide elastomer. These may be the one in which any of a variety of functional groups is introduced, and among these, one type may be used alone or two or more types may be used in combination. Incidentally, in the case where two or more incompatible resins are combined, a conventionally known compatibilizer can be added.

In addition, in the present invention, the above-mentioned thermoplastic resin is in the form of such as powder, particle, pellet, chip, flake, sheet, film, fiber, strip, or irregular form, and there is no particular restriction on the form. However, in the case of a resin, which is hard even at room temperature, it is preferably in the thin-walled form having a high aspect ratio, which is easily deformed efficiently even with a small shearing force, for example, in the form of flake, chip, sheet, film, fiber, strip or the like. The aspect ratio herein means the ratio of the length of the longest axis to the length of the shortest axis of the form (aspect ratio=the longest length/the shortest length), and is preferably 3 or more, more preferably 5 or more. A method of processing into such a form is not particularly limited. For example, in the case where an unmodified thermoplastic resin is in a pellet state, the resin is once melted with an extruder or the like in advance, the discharged molten strand is cooled down while it is compressed with a roller or the like in cooling water, and the obtained product is cut with a usual pelletizer, or the resin is melt-extruded with an extruder or the like whose die hole is in a flat form such as slit, rectangle or prolate ellipsoid, and the obtained melt-extruded product is cooled down in water and pelletized, whereby the form of the resin can be easily changed into a flat form. In addition, it may be processed into a sheet form or a film form by press molding or roll molding. Incidentally, with regard to the size thereof, they may be cut into an appropriate size and employed according to the type or the size of a kneader.

A lamellar inorganic compound to be used in the present invention is not particularly limited as long as it has a structure, in which a number of sheets composed of mainly clay minerals, specifically silicate minerals having a lamellar structure or the like (e.g., tetrahedral sheets of silicon oxide or octahedral sheets of metal hydroxide) are laminated, and has a property of being swollen in water and/or an organic solvent. Examples thereof include montmorillonite, saponite, beidellite, nontronite, hectorite, stevensite, vermiculite, kaolinite, dickite, hallosite, pyrophyllite and the like. In addition, swollen mica, talc, zirconium phosphate or the like can be used. Such a lamellar inorganic compound may be a substitution or derivative thereof. In addition, it may be any of natural products, synthetic products and processed products. Further, among these, one type may be used alone or two or more types may be used by mixing them. Among these, montmorillonite, vermiculite and swollen mica are preferred in terms of the point that they are easily swollen.

In the present invention, in order to promote delamination by expanding the interlayer space of a lamellar inorganic compound and to improve dispersibility in a thermoplastic resin, a lamellar inorganic compound which is swollen with a dispersion medium comprising water and/or an organic solvent in advance is used. Here, as the organic solvent other than water that can be used for swelling the lamellar inorganic compound, though it is not particularly limited, a solvent containing an aromatic compound or a proton donor is preferred. For example, as the aromatic compound, benzene, toluene, xylene, dichlorobenzene, or as a homologue, alkylbenzene, pyridine, quinoline and the like are exemplified. In addition, as the solvent containing a proton donor, an aliphatic alcohol and an ether thereof are exemplified, and examples thereof include methanol, ethanol, propanol, isopropanol, butanol, amyl alcohol, hexanol, cyclohexanol, octanol, ethylene glycol, diethylene glycol, propylene glycol, ethylene glycol monoethyl ether, ethylene glycol diethyl ether, ethylene glycol dimethyl ether, diethylene glycol monomethyl ether, diethylene glycol dimethyl ether, diethylene glycol diethyl ether, diethylene glycol dibutyl ether, tetrahydrofuran, butyl ethyl ether and the like. Other than these, ethylene glycol monoacetylate, ethylene glycol diacetylate, dimethylformamide, dimethylacetamide, N-methyl pyrrolidone or the like can be used. Among these, one type may be used alone or two or more types may be used in combination. Incidentally, such a dispersion medium may contain a solvent other than the dispersion medium or an additive as needed without departing from the purpose of the present invention.

Here, the dispersion medium is appropriately selected according to the type of a thermoplastic resin to be used. However, as a guide, it is preferred to select a dispersion medium having a boiling point which is not lower than the glass transition temperature of a thermoplastic resin to be used. More preferably, it is a dispersion medium having a boiling point which is not lower than the glass transition temperature of a thermoplastic resin and not higher than the melting temperature thereof. For example, in the case where it is a thermoplastic resin having a glass transition temperature which is not higher than 100° C. such as polyethylene, polypropylene, polyvinyl chloride, polyvinylidene chloride, polyvinyl acetate, an ethylene-vinyl acetate copolymer, polystyrene, an acrylonitrile-butadiene-styrene copolymer, polyethylene terephthalate, polybutylene terephthalate, polylactic acid, polycaprolactone, polybutylene succinate, polyamide, polyacetal, any of a variety of rubbers, or a thermoplastic elastomer among the above-mentioned thermoplastic resins, or even if it is a thermoplastic resin having a glass transition temperature which is higher than 100° C., in the case where it is a thermoplastic resin composition containing two or more types in combination, in which at least one type has a glass transition temperature which is not higher than 100° C., water (boiling point: 100° C.), which exists in a large amount in nature and is harmless in terms of health and safety can be most preferably used. In addition, in the case where the glass transition temperature of a thermoplastic resin to be used is higher than 100° C., it may be appropriately selected from the solvents having a boiling point which is higher than 100° C. including, for example, toluene (boiling point: 111° C.), xylene (boiling point: 140° C.), butanol (boiling point: 117° C.), cyclohexanol (boiling point: 161° C.), ethylene glycol (boiling point: 198° C.), propylene glycol (boiling point: 188° C.) and the like.

There is no particular restriction on a method of regulating swelling of a lamellar inorganic compound with a dispersion medium. For example, a method of adding dropwise a predetermined amount of a dispersion medium a little at a time while stirring a lamellar inorganic compound with a mixer or a mortar, adding a dispersion medium in the form of mist by using a nebulizer, or steaming with steam may be used. Alternatively, a method of adding a lamellar inorganic compound to a dispersion medium while stirring may be used. In this case, an arbitrary method such as a method of heating and stirring, a method of ultrasonic stirring or a method of shaking and stirring can be used. In addition, after a small amount of a lamellar inorganic compound is added to a dispersion medium and the compound is allowed to be dispersed, the mixture is desolvated and condensed, whereby the mixture may be adjusted to a desired concentration. Here, the ratio of the lamellar inorganic compound to the dispersion medium in the finally adjusted lamellar inorganic compound swollen with the dispersion medium according to the present invention is from 1:0.2 to 1:100, preferably from 1:0.3 to 1:50, more preferably from 1:0.5 to 1:20 ((lamellar inorganic compound): (dispersion medium)) based on the weight ratio. In the case where the ratio is less than 1:0.2, the lamellar inorganic compound is not sufficiently swollen, whereby a dispersing effect in the resin is small, and in the case where the ratio is higher than 1:100, it takes time for a step of removal of dispersion medium and the productivity is decreased.

Further, in the present invention, in order to improve the affinity between a lamellar inorganic compound and a thermoplastic resin, a lamellar inorganic compound containing a known organizing agent can be used. As the organizing agent, at least one type selected from, for example, (1) a compound having a functional group with an affinity for the surface of a lamellar inorganic compound, (2) a metal salt of sulfonic acid, a metal salt of phosphonic acid or a metal salt of carboxylic acid, (3) an onium salt, (4) a water-soluble polymer and the like can be exemplified. Incidentally, it goes without saying that the water-soluble polymer in (4) can be used not only as an organizing agent, but also as a thermoplastic resin constituting a polymer composite material according to the present invention. In addition, this water-soluble polymer is excellent in an affinity for a water swollen lamellar inorganic compound, it can finely disperse the lamellar inorganic compound at a high concentration, and it is conveniently used in the case where an arbitrary amount of lamellar inorganic compound is incorporated as a master batch.

As the functional group of the compound according to the above-mentioned (1), for example, an acid anhydride group, a carboxylic group, a hydroxyl group, an epoxy group, a thiol group, an ester group, an amide group, a urea group, a urethane group, an ether group, a thioether group, a sulfonic acid group, a phosphonic acid group, a nitro group, an amino group, an oxazoline group, an imide group, a cyano group, an isocyanate group, a halogen atom and the like are exemplified. In addition, aromatic rings such as a benzene ring, a pyridine ring, a pyrrole ring, a furan ring, a thiophene ring and the like are exemplified. As long as a compound has such a functional group, it can be used without particular limitation. As the compound according to the above-mentioned (2), for example, an alkyl sulfonate such as sodium dodecyl sulfonate, an alkyl aryl sulfonate such as sodium alkyl benzene sulfonate, an aryl sulfonate such as sodium benzene sulfonate, an alkyl phosphonate such as sodium dodecyl phosphonate, an alkyl aryl phosphonate such as sodium alkyl benzene phosphonate, an aryl phosphonate such as sodium benzene phosphonate and the like are exemplified. In addition, as the metal in the metal salt, sodium, potassium, calcium, magnesium, aluminum and the like are preferred. As the onium salt according to the above-mentioned (3), for example, octyl ammonium chloride, octyl ammonium bromide, dodecyl ammonium chloride, dodecyl ammonium bromide, octadecyl ammonium chloride, octadecyl ammonium bromide, an ammonium salt or a phosphonium salt of such as aminododecanoate and the like are exemplified. As the water soluble polymer according to the above-mentioned (4), for example, a polyoxy alkylene ether such as polyethylene glycol or polypropylene glycol, a polyoxy alkylene aryl ether such as polyoxyethylene phenyl ether, a polyvinyl alcohol, a cellulose derivative such as methyl cellulose, ethyl cellulose, hydroxyethyl cellulose, hydroxypropyl cellulose or carboxymethyl cellulose, a lignin derivative such as lignin sulfonate, a chitosan derivative such as chitosan hydrochloride, and further polyvinyl sulfonate, polyvinyl benzyl sulfonate, polyvinyl phosphonate, polyvinyl benzyl phosphonate, polyacrylic acid, poly(diallyl dimethyl ammonium chloride), poly(4- vinylpyridine) and the like are exemplified. In addition, even if it is a substance other than these, it can be used as an organizing agent as long as it is a substance having a function capable of being adsorbed or bound to the surface of a lamellar inorganic compound. For example, a surface treating agent such as a silane coupling agent, a titanate coupling agent, or an alumina coupling agent, which is generally used as an inorganic filler can be exemplified. In particular, a silane coupling agent is preferred.

Among these, one type may be used alone or two or more types may be used in combination. In addition, as for such an organizing agent, an organic compound having a molecular weight ranging from 10 to 1,000,000 can be used. In the case of a compound having a molecular weight less than 10, it may volatilize during kneading of a lamellar inorganic compound together with a resin, and in the case of a compound having a molecular weight greater than 1,000,000, the viscosity at the kneading becomes too high, whereby homogeneous mixing cannot be possibly achieved.

There is no particular restriction on a method of producing an organized lamellar inorganic compound. In general, a lamellar inorganic compound as a raw material is stirred and dispersed in a dispersion medium, and an organizing agent is added, whereby the lamellar inorganic compound can be organized by intercalation. By this procedure, the organizing agent enters the interlayer of the lamellar inorganic compound, whereby the lamellar inorganic compound is swollen as a whole. Here, intercalation is referred to as the phenomenon that an electron donor or an electron receptor is inserted in the interlayer of a lamellar substance by the charge transfer force. At this time, the concentration of the lamellar inorganic compound in the dispersion medium is selected from the range generally from 0.01 to 20% by weight, preferably from 0.5 to 10% by weight, particularly preferably from 1 to 5% by weight. In the case where the concentration of the lamellar inorganic compound is less than 0.01% by weight, not only does it take time to remove the dispersion medium in the latter step, but also is the cost of equipment increased because a large container for adjusting the dispersion medium is needed, therefore, it is not preferred. In addition, in the case where the addition amount of the lamellar inorganic compound is higher than 20% by weight, the viscosity of the solution increases, and it becomes difficult to perform stirring, whereby organization may be insufficient. On the other hand, the addition amount of the organizing agent is generally from 0.1 to 5000 parts by weight, and preferably from 0.3 to 1000 parts by weight based on 100 parts by weight of the lamellar inorganic compound. In the case where the addition amount of the organizing agent is less than 0.1 part by weight, an effect on improving the affinity between the thermoplastic resin and the lamellar compound may not be obtained. In addition, in the case where the addition amount is more than 5000 parts by weight, some are not adsorbed or bound to the lamellar inorganic compound, which may cause a decrease in the physical property of the polymer composite material.

If the above-mentioned organized lamellar inorganic compound-containing dispersion medium is desolvated with a centrifuge or a filter press, and the weight ratio of the unmodified lamellar inorganic compound to the solvent is adjusted to 1:0.2 to 1:100, the obtained mixture can be used without further processing. In addition, for transportation or storage, purification and drying treatment are carried out to produce an organized lamellar inorganic compound in the form of powder, then a dispersion medium is added thereto, and in the same manner as above, the weight ratio of the unmodified lamellar inorganic compound to the solvent is adjusted to 1:0.2 to 1:100, and the obtained mixture can also be used. Further, a commercially available organized lamellar inorganic compound in the form of powder is subjected to a similar treatment of adding a dispersion medium and an adjustment treatment, and the obtained mixture can also be preferably used. Examples of such a commercially available organized lamellar inorganic compound in the form of powder include “S-BEN” and “ORGANITE” (trade name) manufactured by Hojun Co. Ltd., which are obtained by denaturing montmorillonite with a quaternary ammonium ion, as well as “lucent” (trade name) manufactured by Co-Op Chemical Co. Ltd., which is obtained by denaturing synthetic smectite with a quaternary ammonium ion and the like.

As a means for attempting to improve the affinity between a lamellar inorganic compound and a thermoplastic resin, not only a method of chemically modifying a lamellar inorganic compound with an organizing agent as described above, but also a method of chemically modifying a thermoplastic resin may be employed. By introducing a functional group having an affinity for a dispersion medium into a thermoplastic resin according to the type of a dispersion medium used in regulating swelling of a lamellar inorganic compound, it can be attempted to improve the affinity for the lamellar inorganic compound. Alternatively, a method of adding, to a thermoplastic resin, some of functional group-modified thermoplastic resins obtained by introducing a functional group having an affinity for the dispersion medium for a swollen lamellar inorganic compound into the same type of thermoplastic resin or another type of thermoplastic resin compatible with it may be employed. For example, in the case where a water swollen lamellar inorganic compound that is not subjected to an organizing treatment is used, and a thermoplastic resin of interest is a hydrophobic thermoplastic resin having a glass transition temperature of not higher than 100° C. such as polyethylene, polypropylene, polystyrene, ethylene-propylene rubber or a styrene ethylene propylene styrene copolymer, by introducing at least one functional group selected from a variety of hydrophilic groups such as a hydroxyl group, a carboxyl group, an amino group, a carbonyl group, a sulfo group, an epoxy group, an imino group and an acid anhydride group into the thermoplastic resin, or by adding, to the hydrophobic thermoplastic resin, some of functional group-modified thermoplastic resins obtained by introducing at least one functional group selected from the above-mentioned hydrophilic groups into the same type of thermoplastic resin or another type of thermoplastic resin compatible with it, it can be attempted to attain the affinity for a water swollen lamellar inorganic compound.

The compounding amount of a lamellar inorganic compound in a thermoplastic resin may be selected so that it is from 0.01 to 300 parts by weight, preferably from 0.05 to 100 parts by weight, more preferably from 0.1 to 50 parts by weight in terms of the unmodified lamellar inorganic compound based on 100 parts by weight of the thermoplastic resin. In the case where the compounding amount is less than 0.01 part by weight, an effect on improving the mechanical physical properties and heat resistance of the polymer composite material is not sufficient, and in the case where the compounding amount is more than 300 parts by weight, the flowability of the polymer composite material decreases significantly, whereby not only is the molding processability thereof reduced, but also is an excessive load during kneading applied to the apparatus, which may cause the apparatus to halt, therefore, it is not preferred.

Subsequently, a process for producing a polymer composite material according to the present invention will be described. A kneader to be used in the present invention is not particularly limited as long as it can shear and knead any of the above-mentioned raw materials and has a temperature control means for heating and cooling. For example, a single screw extruder, a twin screw extruder, a Banbury mixer, a kneader, Brabender, a roll mixer, a mortar mixer and the like can be exemplified. Among these, one type of apparatus may be used alone, or two or more types of apparatuses may be used in combination. However, a kneader to be used may be appropriately selected according to the type and property of a thermoplastic resin, the combination thereof, the form thereof or the like. In particular, a twin screw extruder, a Banbury mixer, a kneader and a roll mixer, which are industrially widely used, can be preferably used. In general, with regard to the controlling of the temperature of a kneader having an outer shell such as a twin screw extruder or a Banbury mixer, the temperature is controlled only at the portion of the outer shell such as a cylinder or a chamber. In the present invention, however, in order to control an increase in the temperature of the resin due to the shearing heat, a kneader having a cooling means at the rotating shaft side in the inside such as a screw or a rotor can be used. Further, in order to exhaust air and/or to drain liquid for the dispersion medium discharged during kneading, a kneader provided with an air exhausting means and/or a liquid draining means such as a vent, a slit barrel, a drainage port, a drainage pump or the like can be preferably used.

In the present invention, by using such a kneader, first, as a first kneading step, kneading of a thermoplastic resin together with a lamellar inorganic compound swollen with a dispersion medium comprising water and/or an organic solvent (hereinafter referred to as a swollen lamellar inorganic compound containing a dispersion medium in some cases) at a temperature which is lower than the melting temperature of the thermoplastic resin and not higher than the boiling point of the dispersion medium is carried out. That is, it is characterized by bringing a thermoplastic resin and a swollen lamellar inorganic compound containing a dispersion medium into contact with each other at a temperature which is lower than the boiling point of the dispersion medium, and kneading them at a low temperature which is lower than the melting temperature of the thermoplastic resin in a state where the lamellar inorganic compound retains the dispersion medium. In other words, the first kneading step is a step of shearing and kneading while maintaining a state where a thermoplastic resin and a lamellar inorganic compound and a dispersion medium (solvent) coexist. In this step, the thermoplastic resin phase to be a matrix is kneaded in a state of solid to half-melted, a higher shearing force than that in a state where it is melt-kneaded is effected, and further, the lamellar inorganic compound is in a state where it is flexible and easy to be delaminated by the dispersion medium, therefore, delamination of the lamellar inorganic compound is efficiently performed while destruction of the interlayer thereof is reduced, and delamination and dispersion of the lamellar inorganic compound in the resin is promoted (step of delamination and dispersion). At this time, by a simultaneous squeezing effect and shearing heat, the dispersion medium is removed from the lamellar inorganic compound. The lower limit of the kneading temperature in this step of delamination and dispersion is not particularly limited, however, it is generally not lower than room temperature, preferably not lower than the glass transition temperature of the thermoplastic resin. The load on the kneader is smaller and the dispersion medium is also easier to be squeezed when the thermoplastic resin phase is in a rubber-like viscoelastic condition which is at not lower than the glass transition temperature of the thermoplastic resin. In addition, a method of bringing the thermoplastic resin and the swollen lamellar inorganic compound containing the dispersion medium into contact with each other may be any, as long as it can bring both into contact with each other at a temperature which is lower than the boiling point of the dispersion medium. The thermoplastic resin and the swollen lamellar inorganic compound containing the dispersion medium may be mixed at a time in advance at room temperature, or the thermoplastic resin may be kneaded in advance at a temperature which is lower than the boiling point of the dispersion medium by being separately supplied, and the swollen lamellar inorganic compound containing the dispersion medium may be added thereto. In addition, in the case where the thermoplastic resin has a good affinity for the dispersion medium used in regulating swelling of the lamellar inorganic compound, the thermoplastic resin may be made to contain the same solvent as this dispersion medium in advance, too. A method of making the thermoplastic resin contain such a solvent is not particularly limited, and for example, a method of immersing the thermoplastic resin in the solvent at a temperature which is not lower than the glass transition temperature of the thermoplastic resin and lower than the boiling point of the solvent, a method of leaving the thermoplastic resin in an atmosphere containing the vapor of the solvent and the like are exemplified. By making the thermoplastic resin contain the same dispersion medium as that in the swollen lamellar inorganic compound and kneading them, it can be attempted to improve the dispersion efficiency of the lamellar inorganic compound in the thermoplastic resin. Subsequently, in a method according to the present invention, as a second kneading step, kneading of the kneaded mixture undergoing the first kneading step is carried out while increasing the temperature to a temperature which is not lower than the boiling point of the dispersion medium. That is, it is characterized by carrying out the kneading by applying a temperature gradient to a high temperature which is not lower than the boiling point of the dispersion medium in a state where delamination of the lamellar inorganic compound and dispersion thereof in the thermoplastic resin proceed. In this step, since the dispersion medium is gradually removed from the kneading system due to a squeezing action and an evaporation action caused by an increase in the temperature, the delaminated lamellar inorganic compound is left in the matrix, and homogenization of dispersion is promoted (step of removal of dispersion medium and homogenization of dispersion). A method of applying a temperature gradient is not particularly limited, and it may be performed continuously or discontinuously. The gradient can be arbitrarily set by taking into account the type and the content of the dispersion medium to be used, the kneading time or the like. However, a temperature gradient in such a manner that the dispersion medium evaporates rapidly may cause aggregation of the lamellar inorganic compound, therefore, it may be avoided. Here, it is only necessary that the reaching temperature for kneading is a temperature which is not lower than the boiling point of the dispersion medium and lower than the thermal decomposition temperature of the thermoplastic resin, and it may be either lower than the melting temperature of the thermoplastic resin or not lower than the melting temperature thereof. In addition, the kneaders involved with the first kneading step and the second kneading step may be the same kneader or different kneaders respectively. In addition, two or more types of kneaders maybe used in combination. Incidentally, in the kneading at low temperature, by appropriately controlling the above-mentioned kneading conditions, the thermoplastic resin in a half-melted state from an unmelted state can be kneaded, however, by utilizing the shearing heat, it is possible to make the kneaded material in a molten state temporarily. In addition, it is possible to control the time when the kneaded material is in such a molten state. By such kneading at low temperature, there is an advantage in that deterioration or denaturation such as hydrolysis or thermal decomposition of the thermoplastic resin to be a matrix can be suppressed.

According to the present invention, for example, in the case where a continuous kneader such as a single screw extruder or a twin screw extruder is used, by setting the temperature of a cylinder, designing a screw, setting the rotation speed thereof, and appropriately arranging the relational position of such as a vent and a drainage port, the steps from the above-mentioned step of delamination and dispersion to the step of removal of dispersion medium and homogenization of dispersion can be continuously and effectively performed along the direction from the upstream to the downstream of the extruder. For example, a raw material comprising a thermoplastic resin and a swollen lamellar inorganic compound containing a dispersion medium is collectively supplied from the upstream of a hopper, kneading zones are provided at the upstream portion and the downstream portion, respectively, further, vents for removal of dispersion medium are provided at two sites: one is provided between the upstream portion and the downstream portion, the other is provided between the downstream kneading zone and the die head. With regard to the setting of the temperature, the temperature at the upstream kneading zone is set to a temperature which is lower than the melting temperature of the thermoplastic resin and lower than the boiling point of the dispersion medium, and a temperature gradient from a temperature which is lower than the boiling point of the dispersion medium to a temperature which is not lower than the boiling point thereof is applied between the upstream kneading zone and the downstream kneading zone, and the temperature at the die head portion is set to a temperature which is not lower than the melting temperature of the thermoplastic resin. By performing extrusion kneading in such a setting of the temperature, the above-mentioned step of delamination and dispersion and the above-mentioned step of removal of dispersion medium and homogenization of dispersion are continuously performed at the upstream portion and at the downstream portion, respectively. Moreover, the kneaded material is ejected from the die head as a molten strand, and can be pelletized by a known method. In the case where the amount of the removed dispersion medium is large, by appropriately providing a drainage ditch or a port for drainage such as a slit barrel with the cylinder portion of the extruder, the drainage efficiency can be increased. According to circumstances, air may be forcibly exhausted by reducing pressure with a vacuum pump in combination.

In the case where kneading is performed by using a closed type batch kneader such as a Banbury mixer, a kneader, or Brabender, for example, the temperature of the kneader is set to a temperature which is lower than the melting temperature of the thermoplastic resin to be used and lower than the boiling point of the dispersion medium, and the thermoplastic resin and the swollen lamellar inorganic compound containing the dispersion medium are collectively or separately fed thereto and kneading is performed, and then, kneading is continuously performed while increasing the temperature appropriately to a temperature which is not lower than the boiling point of the dispersion medium, whereby the lamellar inorganic compound can be homogeneously and finely dispersed in the matrix while evaporating the dispersion medium from a raw material feed port or the like. Incidentally, the kneading time in each step and how to apply a temperature gradient are appropriately set according to the type of the thermoplastic resin to be used, the type and the content of the dispersion medium, the capacity of the kneader to be used, the rotation speed, the temperature controlling ability or the like.

In addition, in the case where the thermoplastic resin is a flexible thermoplastic resin such as polyethylene, polyvinyl chloride, polyvinyl acetate, an ethylene-vinyl acetate copolymer, any of a variety of rubbers, or a thermoplastic elastomer, a roll mixer can also be preferably used. For example, in the case where a general open roll mixer with two front and rear rolls is used, first, the temperature of the rolls are set to a temperature which is not lower than the glass transition temperature and lower than the melting point of the thermoplastic resin to be used and lower than the boiling point of the dispersion medium, and the thermoplastic resin and the swollen lamellar inorganic compound containing the dispersion medium are collectively or separately fed thereto and roll mixing is performed, and then, kneading is continuously performed while the temperature of the rolls is increased appropriately to a temperature which is not lower than the boiling point of the used dispersion medium, whereby the lamellar inorganic compound can be homogeneously and finely dispersed in the matrix while removing the dispersion medium by evaporation. In addition, also in the case where a roll mixer is used, the kneading time in each step and how to apply a temperature gradient are appropriately set according to the type of the thermoplastic resin to be used, the type and the content of the dispersion medium, the capacity of the kneader to be used, the rotation speed, the temperature controlling ability or the like. However, with an open roll mixer, the state of kneading can be confirmed by a visual check, therefore, there is an advantage in that the controlling of the kneading conditions is easily performed. Incidentally, in the case where a roll mixer is used, particularly the thermoplastic resin to be used is preferably in the form which is easy to enter the roll nip, namely, in the form whose aspect ratio is high such as flake, strip, sheet or film, or in the form of powder. However, this does not apply to the case of a thermoplastic resin having flexibility even at room temperature such as a rubber or a thermoplastic elastomer.

In addition, the present invention also provides a polymer composite material which comprises the above-mentioned thermoplastic resin and 0.01 to 100 parts by weight of the unmodified lamellar inorganic compound based on 100 parts by weight of the thermoplastic resin, and in which the lamellar inorganic compound is finely dispersed in a state where the average thickness thereof is about 0.5 μm or less and the maximum thickness thereof is about 1 μm or less. In this way, a polymer composite material which comprises a lamellar inorganic compound dispersed on the order of submicron or smaller can be produced conveniently with a good productivity by the above-mentioned method of the present invention.

In the polymer composite material according to the present invention, depending on the purpose, various additives such as conventionally known plasticizers, thermal stabilizers, light stabilizers, ultraviolet ray absorbents, antiaging agents, pigments, colorants, natural fibers, various inorganic particles, various fillers, antistatic agents, releasing agents, plasticizers, flavors, lubricants, crosslinking (vulcanizing) agents, crosslinking (vulcanizing) accelerators, crystal nucleating agents, crystallization accelerators, flame retardants, foaming agents, softeners, antiseptics, and antibacterial-antifungal agents may be added during mixing or kneading of raw materials or during molding.

### BEST MODE FOR CARRYING OUT THE INVENTION

Hereunder, Examples and Comparative Examples will be disclosed in order to easily understand the present invention. However, the technical scope of the present invention is not limited to these Examples as long as the present invention does not depart from the spirit and the technical scope of the present invention.

First, the used kneader and raw materials are as follows.
[1] Kneader
(a) Twin screw extruder: TEX-30 α, manufactured by Japan Steel Works, LTD.

The cylinder portion of this apparatus was constructed from 12 blocks including C1 to C12 corresponding to respective temperature control blocks. The C1 portion was provided with a raw material feed port; the C6 and C11 portions were provided with a vent. The vent at C11 was connected with a vacuum pump. In addition, the kneading zones for the screws were located between C4 and C5, and between C9 and C10.
(b) Closed type batch kneader: Laboplastomill, manufactured by Toyo Seiki Co., Ltd.
(c) Roll mixer: 6-Inch Roll, manufactured by Kansai-Roll Co., Ltd.
[2] Raw materials
(1) Thermoplastic resin

Polyamide 6 (PA6): 1015B, manufactured by UBE Industries Ltd.,

Polypropylene (PP): J-700GP, manufactured by Idemitsu Sekiyu Kagaku Co.,

Recycled PET flake (R-PET): clear flake with a size of 2 to 5 mm which is obtained by grinding and washing commercially available PET bottles for drink,

Polylactic acid (PLA): LACEA H-100, manufactured by Mitsui Chemicals Co., Ltd.,

Natural rubber (NR): Ribbed Smoked Sheet (RSS No. 4), produced in Thailand,

Styrene butadiene rubber (SBR): Nipol 1502, manufactured by Japan Zeon Co., Ltd.,

Hydrogenated nitrile rubber (H-NBR): Zetpol 2020, manufactured by Japan Zeon Co., Ltd.,

Ethylene-vinyl acetate copolymer (EVA): Novatec LV540, manufactured by Japan Polychem Corporation,

Chlorinated polyethylene (CPE): MR-104, manufactured by Daiso Co., Ltd.
(2) Lamellar inorganic compound

Montmorillonite (powder): Kunipia F, manufactured by Kunimine Co. Ltd.,

Water swollen montmorillonite: which is obtained by mixing montmorillonite and water at a weight ratio of 1:1,

Organized water swollen montmorillonite: which is obtained by dispersing 3 parts by weight of montmorillonite in 97 parts by weight of water while stirring, adding 3 parts by weight of dimethyl octadecyl ammonium chloride to organize montmorillonite, performing a dehydration treatment, and adjusting the water content at about 50% by weight,

Organized montmorillonite (powder): which is obtained by drying and grinding the above-mentioned organized water swollen montmorillonite,

Surface-treated water swollen montmorillonite: which is obtained by dispersing 4 parts by weight of montmorillonite in 96 parts by weight of water while stirring, adding 0.4 part by weight of γ-polyoxyethylene-propyltrimethoxysilane, stirring and mixing the mixture, and then dehydrating the mixture and adjusting the water content at about 50% by weight,

Surface-treated montmorillonite (powder): which is obtained by filtrating the above-mentioned surface-treated water swollen montmorillonite and drying and grinding the filtrate.

Incidentally, the measurement of the content ratio of the lamellar inorganic compound in the polymer composite material obtained in each example, and the evaluation of the dispersibility thereof were carried out by the following methods.

(1) Content Ratio of Lamellar Inorganic Compound

Inorganic ash content ratio derived from the lamellar inorganic compound in any of the obtained polymer composite materials was measured in compliance with JIS-K 7052, which was considered as the content ratio of the lamellar inorganic compound.

(2) Dispersibility of Lamellar Inorganic Compound

Based on the visual observation of the surface and the divided cross-section (divided in liquid nitrogen) of a specimen of any of the obtained polymer composite materials and the observation thereof with a field-emission scanning electron microscope (S-4500, manufactured by Hitachi Ltd.), evaluation was carried out in accordance with the following criteria.
⊙: The existence of a lamellar aggregate can be hardly observed even with an electron microscope.
◯: A few aggregates having an average lamellar thickness of 0.5 ,μm or less can be observed.
×: Aggregates with 100 μm or larger that can be observed on the visual level are scattered.

### Example 1

First, polyamide 6 (PA6) pellet was melt-extruded (240° C.) with a twin screw extruder using a die head whose port was in the form of slit, thereby forming a strip-shaped strand, which was subjected to rolling, then cutting while cooling in a water bath, whereby PA6 in the form of flake (aspect ratio: about 16) with a size of about 0.5 mm×6 mm×8 mm was obtained. After this flake-shaped PA6 was left in an atmosphere in a room (the water content was about 3%), 100 parts by weight (excluding the water content) of the flake-shaped PA6 and water swollen montmorillonite, which had been weighed so as to yield the amount of the unmodified montmorillonite of 3 parts by weight based on 100 parts by weight of PA6, were mixed. These were fed to a twin screw extruder in which the cylinder temperatures for C2 to C5, C6 to C8, C9, C10, C11 to 12, and DH were set at 60, 80, 100, 150, 220 and 240° C., respectively, and the screw rotation speed was set at 200 min⁻¹, and extrusion kneading was carried out while the downstream vent (C11) was under vacuum. The discharged molten strand was cooled in a water bath, and pelletized, whereby pellet of PA6/montmorillonite was produced. By using this pellet, an injection molded specimen (10×120×4 mm) was prepared, and the flexural modulus and the flexural strength were measured in compliance with JIS K 7171, and the deflection temperature under load (HDT) was measured in compliance with JIS K 7191. The results are shown in Table 1. Incidentally, during the kneading, it was observed that water vapor was released from the upstream vent (C6).

### Example 2

Polypropylene (PP) pellet was melt-extruded (180° C.) by the same method as in Example 1, thereby forming it in the shape of flake. Then, 100 parts by weight of this flake-shaped PP and organized water swollen montmorillonite, which had been weighed so as to yield the amount of the unmodified montmorillonite of 5 parts by weight based on 100 parts by weight of PP, were mixed. These were fed to a twin screw extruder in which the cylinder temperatures for C2 to C5, C6 to C8, C9, C10, C11 to 12, and DH were set at 60, 80, 90, 100, 150 and 180° C., respectively, and the screw rotation speed was set at 160 min⁻¹, extrusion kneading was carried out while the downstream vent (C11) was under vacuum, and pellet of PP/montmorillonite was produced in the same manner as in Example 1. By using the obtained pellet, an injection molded specimen was prepared, and the flexural properties and the deflection temperature under load were measured by the same testing methods as in Example 1. The results are shown in Table 1. Also in this case, during the kneading, it was observed that water vapor was released from the upstream vent (C6) in the same manner as in Example 1.

### Example 3

One hundred parts by weight of Recycled PET flake (R-PET) and surface-treated water swollen montmorillonite, which had been weighed so as to yield the amount of the unmodified montmorillonite of 5 parts by weight based on 100 parts by weight of R-PET, were mixed. These were fed to a twin screw extruder in which the cylinder temperatures for C2 to C5, C6 to C7 and C8 to C12 were set at 60, 80 and 100° C., respectively, and the screw rotation speed was set at 200 min^{31 1}, while the die head was made in an open state, extrusion kneading was carried out, and a kneaded material of R-PET/montmorillonite was produced. The kneaded discharged material was an irregular-shaped solid material with a size of about 10 to 30 mm, which was passed through a grinder mill, thereby forming a fine fragment with a size of about 2 to 3 mm. Then, an injection molded specimen was prepared, and the flexural properties and the deflection temperature under load were measured by the same testing methods as in Example 1. The results are shown in Table 1. In this case, during the kneading, it was observed that water vapor was released from the upstream vent (C6), the downstream vent (C11) and the discharge port.

### Example 4

Polylactic acid (PLA) pellet was melt-compressed with a pressing machine and quenched, thereby forming a transparent sheet with a thickness of about 0.5 mm. Then, the sheet was cut into strips of about 10 mm×100 mm, which were used as a resin material before kneading. One hundred parts by weight of this strip-shaped PLA and organized water swollen montmorillonite, which had been weighed so as to yield the amount of the unmodified montmorillonite of 5 parts by weight based on 100 parts by weight of PLA, were mixed. The mixture was fed to Laboplastomill in which the chamber temperature was set at 70° C. and the rotor rotation speed was set at 80 min^{31 1}, and the kneading was continued until the torque reached a rising zone from a stable zone. Thereafter, kneading was carried out for 2 minutes while increasing the temperature to 80° C. in response to the rising of the torque, and kneading was further carried out for 1 minute while increasing the temperature to 90° C. Finally, the kneading was carried out for 1 minute while increasing the temperature to 100° C. until vapor was not released from the raw material feed port. The thus obtained kneaded material of PLA/montmorillonite was subjected to hot pressing (200° C.), thereby forming a specimen of 10×120×4 mm. Then, the flexural properties and the deflection temperature under load were measured by the same testing methods as in Example 1. The results are shown in Table 1.

### COMPARATIVE EXAMPLE 1

One hundred parts by weight of polyamide 6 (PA6) and 3 parts by weight of montmorillonite powder were fed to a twin screw extruder, and melt-kneading was carried out by setting the cylinder temperature at 240° C. and the screw rotation speed at 200 min⁻¹, whereby pellet of PA6/montmorillonite was obtained. The preparation of a specimen of the kneaded material and the measurement of the physical properties were carried out in the same manner as in Example 1. The results are shown in Table 1.

### COMPARATIVE EXAMPLE 2

One hundred parts by weight of polypropylene (PP) and 5 parts by weight of organized montmorillonite powder, which had been weighed so as to yield the amount of the unmodified montmorillonite of 5 parts by weight based on 100 parts by weight of PP, were fed to a twin screw extruder, and melt-kneading was carried out by setting the cylinder temperature at 180° C. and the screw rotation speed at 160 min⁻¹, whereby pellet of PP/montmorillonite was obtained. The preparation of a specimen of the kneaded material and the measurement of the physical properties were carried out in the same manner as in Example 2. The results are shown in Table 1.

### COMPARATIVE EXAMPLE 3

One hundred parts by weight of recycled PET flake (R-PET) and 5 parts by weight of surface-treated montmorillonite powder, which had been weighed so as to yield the amount of the unmodified montmorillonite of 5 parts by weight based on 100 parts by weight of R-PET, were fed to a twin screw extruder, and melt-kneading was carried out by setting the cylinder temperature at 280° C. and the screw rotation speed at 200 min⁻¹, whereby pellet of R-PET/montmorillonite was obtained. The preparation of a specimen of the kneaded material and the measurement of the physical properties were carried out in the same manner as in Example 3. The results are shown in Table 1.

### COMPARATIVE EXAMPLE 4

One hundred parts by weight of polylactic acid (PLA) and 5 parts by weight of montmorillonite powder were fed to Laboplastomill, and melt-kneading was carried out for 5 minutes by setting the chamber temperature at 200° C. and the rotor rotation speed at 80 min⁻¹, whereby a kneaded material of PLA/montmorillonite was obtained. The preparation of a specimen of the kneaded material and the measurement of the physical properties were carried out in the same manner as in Example 4. The results are shown in Table 1.

### Example 5

One hundred parts by weight of natural rubber (NR) and water swollen montmorillonite, which had been weighed so as to yield the amount of the unmodified montmorillonite of 5 parts by weight based on 100 parts by weight of NR, were fed to Laboplastomill in which the chamber temperature was set at 50° C. and the rotor rotation speed was set at 60 min⁻¹, and the kneading was continued until the torque reached a rising zone from a stable zone. Thereafter, kneading was carried out for 2 minutes while increasing the temperature to 70° C. in response to the rising of the torque, and kneading was further carried out for 1 minute while increasing the temperature to 80° C. Finally, the kneading was carried out for 1 minute while increasing the temperature to 100° C. until vapor was not released from the raw material feed port. The thus obtained kneaded material of NR/montmorillonite was transparent and an aggregate of montmorillonite was not observed. This kneaded material was formed into a sheet through 6-Inch Roll, and then it was adjusted to form a sheet with a thickness of 2 mm with a pressing machine. This sheet was punched into a dumbbell No. 3 specimen, which was subjected to a tensile test. Incidentally, the tensile test was carried out in compliance with JIS K 6251, the values of the stress at 100%, 200% and 300% elongation were obtained. In addition, the tensile modulus was also determined from the slope of a tangential line of the initial region of the stress-strain curve. The results are shown in Table 2.

### Example 6

The kneading and the tensile test were carried out in the same manner as in Example 5 except for using styrene butadiene rubber (SBR) as a thermoplastic resin and organized water swollen montmorillonite as a lamellar inorganic compound. The results are shown in Table 2. Incidentally, the appearance of the obtained kneaded material of SBR/montmorillonite here was also transparent and an aggregate of montmorillonite was not observed.

### COMPARATIVE EXAMPLE 5

Only natural rubber (NR) was fed to Laboplastomill in which the chamber temperature was set at 60° C. and the rotor rotation speed was set at 60 min⁻¹, and mastication was carried out for 5 minutes, which was formed into a sheet with 6-Inch Roll. Then, a tensile specimen was adjusted from this sheet and a tensile test was carried out by the same methods as in Example 5. The results are shown in Table 2.

### COMPARATIVE EXAMPLE 6

This Example is the same as Comparative Example 5 except for using styrene butadiene rubber (SBR) as a thermoplastic resin. The results are shown in Table 2.

### Example 7

To the kneaded material of NR/montmorillonite obtained in Example 5, 3 parts by weight of sulfur as a vulcanizing agent and 1 part by weight of a vulcanizing accelerator (Nocceler NS-P, manufactured by OuchiShinko Chemical Industrial Co., Ltd.) based on 100 parts by weight of NR were added, kneaded with 6-Inch Roll (roll temperature: 60° C.), and discharged in the form of sheet, which was pressed at 150° C. for 40 minutes, thereby adjusting a sheet with a thickness of 2 mm. This vulcanized sheet was subjected to a tensile test in the same manner as in Example 5. The results are shown in Table 2.

### Example 8

To the kneaded material of SBR/montmorillonite obtained in Example 6, 2 parts by weight of sulfur and 1.5 parts by weight of a vulcanizing accelerator (Nocceler NS-P, manufactured by OuchiShinko Chemical Industrial Co., Ltd.) based on 100 parts by weight of SBR were added, kneaded with 6-Inch Roll (roll temperature: 60° C.), and discharged in the form of sheet, which was pressed at 160° C. for 40 minutes, thereby adjusting a sheet with a thickness of 2 mm. This vulcanized sheet was subjected to a tensile test in the same manner as in Example 6. The results are shown in Table 2.

### Example 9

Kneading was carried out under the same conditions as in Example 5 except for using hydrogenated nitrile rubber (H-NBR) as a thermoplastic resin, whereby a kneaded material of H-NBR/montmorillonite was obtained. To this kneaded material, 8 parts by weight of an organic peroxide (Peroxymon F-40, manufactured by Nippon Oil and Fat Corporation) as a vulcanizing agent based on 100 parts by weight of H-NBR was added, kneaded with 6-Inch Roll (roll temperature: 60° C.), and discharged in the form of sheet, which was pressed at 170° C. for 15 minutes, thereby adjusting a sheet with a thickness of 2 mm. This vulcanized sheet was subjected to a tensile test in the same manner as in Example 5. The results are shown in Table 2.

### COMPARATIVE EXAMPLE 7

One hundred parts by weight of natural rubber (NR) and 5 parts by weight of montmorillonite powder were kneaded for 5 minutes with Laboplastomill in which the chamber temperature was set at 60° C. and the rotor rotation speed was set at 60 min⁻¹, then this kneaded material of NR/montmorillonite was subjected to a vulcanization treatment and a tensile test in the same manner as in Example 7. The results are shown in Table 2. Incidentally, the obtained kneaded material of NR/montmorillonite here was not transparent, and many aggregates of montmorillonite that could be confirmed on the visual level were observed.

### COMPARATIVE EXAMPLE 8

This Example is the same as Example 7 except for using a masticated material of NR in Comparative Example 5 as a kneaded material before vulcanization. The results are shown in Table 2.

### COMPARATIVE EXAMPLE 9

This Example is the same as Example 8 except for using a masticated material of SBR in Comparative Example 6 as a kneaded material before vulcanization. The results are shown in Table 2.

### COMPARATIVE EXAMPLE 10

Only hydrogenated nitrile rubber (H-NBR) was kneaded for 5 minutes with Laboplastomill in which the chamber temperature was set at 60° C. and the rotor rotation speed was set at 60 min⁻¹, then this masticated material of H-NBR was subjected to a vulcanization treatment and a tensile test in the same manner as in Example 9. The results are shown in Table 2.

### Example 10

Ethylene-vinyl acetate copolymer (EVA) pellet was melt-compressed with a pressing machine, thereby forming a transparent sheet with a thickness of about 1 mm. Then, the sheet was cut into strips of about 10 mm×100 mm, which were used as a resin material before kneading. One hundred parts by weight of this strip-shaped EVA and water swollen montmorillonite, which had been weighed so as to yield the amount of the unmodified montmorillonite of 5 parts by weight based on 100 parts by weight of EVA, were prepared. First, about half amount of the total strip-shaped EVA was fed to a roll mixer in which the roll temperature was set at 90° C. and the rotation speeds of the front and rear rolls were set at 30 and 25 min⁻¹, respectively, and EVA was wound around the front roll. Thereafter, once the roll temperature was decreased to 70° C., and kneading was carried out for 2 minutes while feeding water swollen montmorillonite and the remaining strip-shaped PLA. Subsequently, while visually observing that the kneaded material wound around the front roll was gradually rendered transparent, kneading was carried out while increasing the temperature at a rate of 10° C. per about 2 minutes up to 100° C. until vapor did not occur. This kneaded material was discharged in the form of sheet, and then it was melt-compressed with a pressing machine thereby forming a sheet with a thickness of 1 mm. This sheet was punched into a dumbbell No. 2 specimen in compliance with JIS K 7113, which was subjected to a tensile test at a testing rate of 50 mm/min. Incidentally, in the tensile test here, the tensile modulus and the values of the stress at 100%, 300% and 500% elongation were obtained. The results are shown in Table 3.

### Example 11

This Example is the same as Example 10 except for using chlorinated polyethylene (CPE) powder as a resin material before kneading. The results are shown in Table 3.

### COMPARATIVE EXAMPLE 11

This Example is the same as Example 10 except for using montmorillonite powder as a lamellar inorganic compound. The results are shown in Table 3. Incidentally, in the obtained kneaded material here, many aggregates of montmorillonite that could be visually confirmed were observed.

### COMPARATIVE EXAMPLE 12

This Example is the same as Example 11 except for using montmorillonite powder as a lamellar inorganic compound. The results are shown in Table 3. Incidentally, also in the obtained kneaded material here, many aggregates of montmorillonite that could be visually confirmed were observed.

### REFERENCE EXAMPLE 1

Ethylene-vinyl acetate copolymer (EVA) pellet was melt-compressed with a pressing machine, thereby forming a sheet with a thickness of 1 mm, and this sheet was subjected to a tensile test in the same manner as in Example 10. The results are shown in Table 3.

### REFERENCE EXAMPLE 2

Chlorinated polyethylene (CPE) powder was melt-compressed with a pressing machine, thereby forming a sheet with a thickness of 1 mm, and this sheet was subjected to a tensile test in the same manner as in Example 11. The results are shown in Table 3.

TABLE 1

| | Type of | | Ash | Flexural | Flexural | HOT 1.8 | |
|---|---|---|---|---|---|---|---|
| | thermoplastic | Type of lamellar inorganic | content | modulus | strength | MPa | |
| | resin | compound | (%) | (GPa) | (MPa) | (° C.) | Dispersibility |
| Example 1 | PA6 | Water swollen | 2.7 | 3.5 | 123 | 131 | ◯ |
| Example 2 | PP | Organized water swollen | 4.8 | 2.6 | 89 | 83 | ◯ |
| Example 3 | R-PET | Surface-treated water swollen | 4.8 | 5.1 | 132 | 133 | ⊚ |
| Example 4 | PLA | Organized water swollen | 4.9 | 6.2 | 115 | 76 | ⊚ |
| Comparative | PA6 | Dried (powder) | 2.9 | 2.6 | 109 | 67 | x |
| Example 1 | | | | | | | |
| Comparative | PP | Organized powder | 4.7 | 1.8 | 51 | 62 | x |
| Example 2 | | | | | | | |
| Comparative | R-PET | Surface-treated powder | 4.9 | 2.7 | 91 | 65 | x |
| Example 3 | | | | | | | |
| Comparative | PLA | Dried (powder) | 4.8 | 3.5 | 98 | 57 | x |
| Example 4 | | | | | | | |

TABLE 2

| | Type of | Type of lamellar | Ash | Tensile | | | | | |
|---|---|---|---|---|---|---|---|---|---|
| | thermoplastic | inorganic | content | modulus | Tensile strength (MPa) | | | Tensile | |
| | resin | compound | (%) | (MPa) | M₁₀₀ | M₂₀₀ | M₃₀₀ | elongation (%) | Dispersibility |
| Example 5 | NR | Water swollen | 5.1 | 1.4 | 0.23 | 0.21 | 0.24 | 305 | ⊚ |
| Example 6 | SBR | Organized | 4.8 | 2.4 | 0.34 | 0.32 | 0.25 | 320 | ⊚ |
| | | water swollen | | | | | | | |
| Comparative | NR | None | — | 0.7 | 0.16 | — | — | 160 | — |
| Example 5 | | | | | | | | | |
| Comparative | SBR | None | — | 1.0 | 0.22 | 0.23 | 0.20 | 310 | — |
| Example 6 | | | | | | | | | |
| Example 7 | Vulcanized | Water swollen | 5.1 | 1.9 | 0.72 | 1.25 | 1.93 | 500 | ⊚ |
| | NR | | | | | | | or higher | |
| Example8 | Vulcanized | Organized | 4.8 | 4.1 | 1.52 | 2.81 | 4.14 | 380 | ⊚ |
| | SBR | water swollen | | | | | | | |
| Example 9 | Vulcanized | Water swollen | 4.9 | 4.7 | 2.6 | 5.9 | — | 260 | ⊚ |
| | H-NBR | | | | | | | | |
| Comparative | Vulcanized | Dried (powder) | 5.0 | 1.1 | 0.50 | 0.78 | 1.02 | 500 | x |
| Example 7 | NR | | | | | | | or higher | |
| Comparative | Vulcanized | None | — | 1.0 | 0.43 | 0.62 | 0.86 | 500 | — |
| Example 8 | NR | | | | | | | or higher | |
| Comparative | Vulcanized | None | — | 1.8 | 0.83 | 1.33 | — | 295 | — |
| Example 9 | SBR | | | | | | | | |
| Comparative | Vulcanized | None | — | 3.7 | 1.8 | — | — | 170 | — |
| Example 10 | H-NBR | | | | | | | | |

TABLE 3

| | Type of | | | | Tensile | | | |
|---|---|---|---|---|---|---|---|---|
| | thermoplastic | Type of lamellar | Ash content | Tensile modulus | strength (MPa) | | | |
| | resin | inorganic compound | (%) | (MPa) | M₁₀₀ | M₃₀₀ | M₅₀₀ | Dispersibility |
| Example 10 | EVA | Water swollen | 4.6 | 81.4 | 5.7 | 11.7 | 19.8 | ◯ |
| Example 11 | CPE | Water swollen | 4.7 | 11.2 | 1.2 | 2.9 | 4.9 | ⊚ |
| Comparative | EVA | Dried (powder) | 4.7 | 54.1 | 5.1 | 10.5 | 17.5 | x |
| Example 11 | | | | | | | | |
| Comparative | CPE | Dried (powder) | 4.8 | 5.3 | 0.8 | 2.0 | 3.6 | x |
| Example 12 | | | | | | | | |
| Reference | EVA | None | — | 53.7 | 4.9 | 10.1 | 17.4 | — |
| Example 1 | | | | | | | | |
| Reference | CPE | None | — | 4.5 | 0.7 | 1.8 | 3.3 | — |
| Example 2 | | | | | | | | |

Table 1 shows Examples relating to polymer composite materials containing a thermoplastic resin having an elastic modulus of 1 GPa or higher as a matrix. In addition, Table 2 and Table 3 show Examples relating to polymer composite materials containing a thermoplastic resin, a rubber or an elastomer having a low elastic modulus as a matrix. In Table 1, Examples 1 to 4 are polymer composite materials containing a lamellar inorganic compound produced by the production process according to the present invention, and Comparative Examples 1 to 4 are polymer composite materials which are produced by simply kneading a thermoplastic resin and a lamellar inorganic compound by a common melt-kneading method. As is clear from this Table 1, by using a common melt-kneading method, delamination and dispersion of a lamellar inorganic compound in a thermoplastic resin are not effected; therefore, a polymer composite material in which a lamellar inorganic compound is finely dispersed cannot be obtained. On the contrary, the specimens of Examples 1 to 4 have an excellent dispersibility of a lamellar inorganic compound, and a significant improvement of mechanical strength and heat resistance is observed. In Table 2, Examples 5 and 6 are unvulcanized rubber specimens containing a lamellar inorganic compound produced by the production process according to the present invention, and it is found that the green strength thereof (strength of unvulcanized rubber) is significantly improved compared with the specimens which does not contain a lamellar inorganic compound (Comparative Examples 5 and 6). In addition, as for the vulcanized rubbers, it is found that the elastic modulus and the strength of the specimens produced by the production process according to the present invention (Examples 7 to 9) are improved to a large extent compared with the blank specimens (Comparative Examples 8 to 10). Comparative Example 7 is a specimen obtained by performing kneading by the same kneading procedure as in Example 5, however, an lamellar inorganic compound which had not swollen with a dispersion medium was used, the dispersibility of a lamellar inorganic compound is poor and the effect on improving the physical property is low. In Table 3, Examples 10 and 11 are flexible polymer composite materials containing a lamellar inorganic compound produced by the production process according to the present invention, and it is found that the dispersibility of a lamellar inorganic compound is superior and the elastic modulus and the strength thereof are high compared with the specimens using a lamellar inorganic compound which does not contain a dispersion medium (Comparative Examples 11 and 12). Reference Examples 1 and 2 show the tensile physical properties of the matrix itself as a reference. Thus, as is clear from Tables 1 to 3, the polymer composite materials produced by the production process according to the present invention are excellent in dispersibility of a lamellar inorganic compound and also excellent in mechanical strength and heat resistance.

### INDUSTRIAL APPLICABILITY

According to the present invention, a polymer composite material which comprises a thermoplastic resin and a lamellar inorganic compound dispersed therein on the order of submicron to nanometer and is excellent in mechanical properties, heat resistance, etc. can be produced industrially advantageously with good productivity by utilizing a conventional kneader without resorting to a special kneader. Moreover, the production process according to the present invention can be applied to a wide variety of thermoplastic resins compared with a conventional art.

1. A process for producing a polymer composite material which comprises:
kneading a thermoplastic resin together with a lamellar inorganic compound swollen with a dispersion medium selected from the group consisting of water, an organic solvent and a combination thereof, with a shearing kneader at a temperature lower than the melting temperature of the thermoplastic resin and not higher than the boiling point of the dispersion medium; and
kneading the resultant mixture while increasing the temperature to a temperature not lower than the boiling point of the dispersion medium.

2. The process for producing a polymer composite material according to claim 1, wherein the weight ratio of the lamellar inorganic compound to the dispersion medium in the lamellar inorganic compound swollen with the dispersion medium is from 1:0.2 to 1:100.

3. The process for producing a polymer composite material according to claim 1, wherein the lamellar inorganic compound contains an organizing agent.

4. The process for producing a polymer composite material according to claim 1, wherein the boiling point of the dispersion medium is not lower than the glass transition temperature of the thermoplastic resin.

5. The process for producing a polymer composite material according to claim 1, wherein the thermoplastic resin is in the form of flake, chip, sheet, film, fiber, strip or the like shape whose ratio of the length of the longest axis to the length of the shortest axis (aspect ratio) is 3 or more.

6. The process for producing a polymer composite material according to claim 1, wherein the shearing kneader has at least one or more air exhausting means and/or liquid draining means such as a vent and a slit barrel.

7. The process for producing a polymer composite material according to claim 1, wherein the thermoplastic resin is made to contain a solvent of the same type as the dispersion medium used in regulating swelling of the lamellar inorganic compound and/or a solvent having an affinity for the dispersion medium.

8. The process for producing a polymer composite material according to claim 1, wherein the thermoplastic resin contains a functional group having an affinity for the dispersion medium used in regulating swelling of the lamellar inorganic compound.

9. The process for producing a polymer composite material according to claim 1, wherein the thermoplastic resin contains another type of thermoplastic resin compatible with it, and the another type of thermoplastic resin has a functional group having an affinity for the dispersion medium used in regulating swelling of the lamellar inorganic compound.

10. A polymer composite material, obtained by the process comprising:
kneading a thermoplastic resin together with a lamellar inorganic compound swollen with a dispersion medium selected from the group consisting of water, an organic solvent and a combination thereof, with a shearing kneader at a temperature lower than the melting temperature of the thermoplastic resin and not higher than the boiling point of the dispersion medium; and
kneading the resultant mixture while increasing the temperature to a temperature which is not lower than the boiling point of the dispersion medium, wherein the substantial content ratio of the lamellar inorganic compound is from 0.01 to 100 parts by weight based on 100 parts by weight of the thermoplastic resin, and the lamellar inorganic compound is finely dispersed in a state where the average thickness thereof is about 0.5 μm or less and the maximum thickness thereof is about 1 μm or less.

11. The polymer composite material according to claim 10, wherein the lamellar inorganic compound is a lamellar inorganic compound containing an organizing agent.

12. The polymer composite material according to claim 10, wherein the thermoplastic resin is made to contain a solvent of the same type as the dispersion medium used in regulating swelling of the lamellar inorganic compound and/or a solvent having an affinity for the dispersion medium.

13. The polymer composite material according to claim 10, wherein the thermoplastic resin contains a functional group having an affinity for the dispersion medium used in regulating swelling of the lamellar inorganic compound.

14. The polymer composite material according to claim 10, wherein the thermoplastic resin contains another type of thermoplastic resin compatible with it, and the another type of thermoplastic resin has a functional group having an affinity for the dispersion medium used in regulating swelling of the lamellar inorganic compound.
